(19) United States
(12) Patent Application Publication
(10) Pub. No.: US 2002/0075366 A1
(43) Pub. Date: Jun. 20, 2002

(54) Liquid ink tank with integral capillary

(75) Inventors: Thomas W. Smith, Penfield, NY (US); Alexander N. Klymachyov, Rochester, NY (US)

Correspondence Address: John E. Beck, Xerox Corporation, Xerox Square 20A, Rochester, NY, 14644, US

(73) Assignee: Xerox Corporation.

(21) Appl. No.: 09/742,965

(22) Filed: Dec. 20, 2000

(51) Int. Cl. B41J 2/175

(52) U.S. Cl. 347/86

(57) ABSTRACT

A fluid cartridges, such as a cartridge for storing ink for use in an ink jet printer. The cartridge includes a fluid chamber for storing fluid, a fluid outlet and a vent opening. A capillary member having an internal capillary chamber is attached to the fluid outlet port. A plurality of ribs in the capillary chamber terminate a short distance from the inner surface of the capillary chamber, and thereby define a plurality of capillary gaps or openings. An ink outlet opening is formed in an end of the capillary member remote from the in outlet port in the cartridge, whereby the fluid chamber is in fluid communication with the external environment via the vent opening, the capillary chamber, and the ink outlet port.

### FIELD OF THE INVENTION

The present invention relates to ink cartridges or tanks used for supplying liquid ink to a printhead in an ink jet printing apparatus. More specifically, the present invention relates to structure and method of maintaining a desired negative pressure within the ink cartridge.

### BACKGROUND OF THE INVENTION

In existing ink jet printing devices, the printhead typically comprises one or more ink filled channels communicating with a relatively small supply chamber, or manifold, at one end, with an opening defining a nozzle at the opposite end. Droplets of ink are emitted or “jetted” out the nozzle onto a sheet of paper in a controlled on demand fashion, in order to generate a desired image on the paper. Various methods and devices for drop on demand ink jet printing, such as thermal, piezo, and acoustic ink jet printers, are well understood in the art and are not described in detail herein.

In current practical embodiments of drop on demand ink jet printers, it has been found that the printers work most effectively when the pressure of the ink in the printhead nozzle is kept within a predetermined range of gauge pressures. Specifically, during the periods of operation in which an individual nozzle or an entire printhead is not actively emitting a droplet of ink, it is important that a certain negative pressure, or “back pressure,” exists in each of the nozzles and within the ink supply manifold of the printhead.

The term “negative pressure”, as contained herein, means somewhat below the pressure of the external ambient environment, as is well understood in the art. Providing a negative or backpressure within the manifold and nozzles prohibits ink from dripping from the nozzles. The attributes of creating and maintaining such a negative or reduced pressure are described in further detail in U.S. Pat. No. 5,289,212, the contents of which are hereby incorporated herein.

The ink is typically supplied to the printhead from a replaceable ink cartridge that contains a supply of ink in an ink chamber or reservoir. When the ink in the ink cartridge has been depleted, the depleted cartridge is removed and a new full ink cartridge is installed in the printer. As with the printhead, it is desirable and known in the art to maintain a reduced pressure in the ink chamber and thereby prohibit ink from dripping from the cartridge's ink outlet during installation and removal of the cartridge from the printer, as well as during periods in which ink is not being jetted from the printhead.

Using a porous wick is a simple and inexpensive way to maintain the desired negative pressure within the ink cartridge. The wick is frequently formed of an open celled foam material and is placed between the ink cavity and the ink outlet. The wick, however, fills a considerable portion of the interior volume of the ink cartridge and therefore reduces the volume available in the cartridge for storing ink. Furthermore, some of the ink absorbed by the porous wick cannot be drawn therefrom by the ink jet head. As a result, using a wick reduces the volume of ink that may be stored in a cartridge and causes some of the ink stored in the cartridge to become trapped in the wick. Therefore, the useful ink storage capacity for a given size cartridge is greatly reduced when a wick is located in the cartridge.

The use, or at least the effective use, of various beneficial additives may be precluded by the use of a porous wick. This is particularly the case with ingredients that are incorporated in the ink at low concentrations, less than 1% by weight. For example, it has been found that satellites and misting in ink jet printing can be reduced or eliminated by incorporation of 50-500 ppm of ultra-high molecular weight, water soluble polymers (Bradley B. Branham, U.S. Pat. No. 5,814,683; Douglas E. Burger, David Erdtmann and Brian G. Price, EP937759). Because of the high surface area of foam or felt wicks, these ingredients might be essentially removed by adsorption on the wicking material. The concentration of other ink ingredients, such as jetting aids, that enhance bubble nucleation and drop ejection; and surfactants and penetrants, that are incorporated in inks at low concentrations to optimize drying and print characteristics (i.e., solid area mottle, line edge acuity and bleed), must often be increased to compensate for material absorbed on wicking materials.

U.S. Pat. No. 4,791,438 discloses an ink jet pen having an ink supply housing which includes a primary ink reservoir and a secondary ink reservoir. A balancing capillary member is positioned within the ink supply housing and includes an ink flow path that extends between the primary ink reservoir and the secondary ink reservoir. This capillary member is operative to draw ink from the primary ink reservoir and into or toward the secondary ink reservoir by capillary action as temperature and pressure within the primary ink reservoir increases. Conversely, when temperature and pressure in the housing decreases, ink will be drawn back into or toward the primary ink reservoir. In addition, the primary ink reservoir is connected by way of a suitable ink feed path to an ink jet printhead for supplying ink to the printhead during an ink jet printing operation. U.S.S.R. patent application SU 491829 A discloses an ink cartridge having a similar capillary vent arrangement.

U.S. Pat. No. 5,963,239 discloses an ink jet recording apparatus having a capillary member which defines a plurality of capillary paths disposed within the ink supply path upstream of the stagnation point or flow boundary occurring at the connection of the recording head to the ink supply tube. These capillary paths are separated a distance away from the flow boundary and included angled walls and cross sections to enable fractionation of larger, potentially ink occluding bubbles.

### SUMMARY OF THE INVENTION

One form of the present invention provides an ink cartridge for supplying ink on demand to a printhead of an inkjet printer. The cartridge comprises a housing having a plurality of outer walls defining an ink chamber for storing ink, with an outlet opening through one of the outer walls for delivering ink to an inkjet printhead. A capillary member having spaced first and second walls joined by edge walls defining a capillary chamber between the opposing walls. One of the walls of the capillary member adjoining one of the housing outer walls. A plurality of fins extending from the first wall of the capillary member toward the second wall and transversely across the capillary chamber. Outer ends of the fins are spaced from the second wall, thereby defining a plurality of capillary spaces between the ends of the fins and the second wall. A fluid passage in one of the walls of the capillary chamber fluidly communicates a first end of the capillary chamber with the ink chamber. A vent opening through one of the walls of the capillary member fluidly communicates a second opposing end of the capillary chamber with the external environment.

Another form of the invention provides a cartridge according to the preceding paragraph, wherein the first wall is a hollow tubular outer wall and the second wall is an axially extending core centrally located within the tubular outer wall. An ink outlet passage extends longitudinally through a center of the core. One end of the outlet passage is in fluid communication with the ink outlet opening and the other end of the fluid passage is open for delivering ink to an inkjet printhead.

An additional form of the invention provides an ink cartridge for supplying ink on demand to a printhead of an inkjet printer. The cartridge comprises a housing having a plurality of outer walls defining an ink chamber for storing ink. An outlet opening extends through one of the outer walls for delivering ink to an inkjet printhead. A capillary member having a plurality of outer walls defining a capillary chamber. One of the walls of the capillary member adjoins one of the housing outer walls. A fluid passage extends through the adjoining walls communicating a first end of the capillary chamber with the ink chamber. A vent opening in one of the capillary member outer walls communicates an opposite end of the capillary chamber with the external environment. A plurality of ribs extending from the first wall of the capillary member toward an opposing second wall of the capillary member. Outer ends of the fins are spaced from the second wall, thereby defining a plurality of capillary spaces between the ends of the fins and the second wall.

### BRIEF DESCRIPTION OF THE DRAWINGS

The present invention will now be described, by way of example, with reference to the accompanying drawings, of which:

FIG. 1 is a side cross-sectional illustrative view of an improved ink cartridge incorporating an integral capillary according to a first embodiment of the present invention;

FIG. 2 is an exploded perspective illustrative view of the ink cartridge of FIG. 1; and

FIG. 3 is side cross-sectional illustrative view of an improved ink cartridge incorporating an integral capillary according to a second embodiment of the present invention.

### DETAILED DESCRIPTION OF EMBODIMENTS OF THE INVENTION

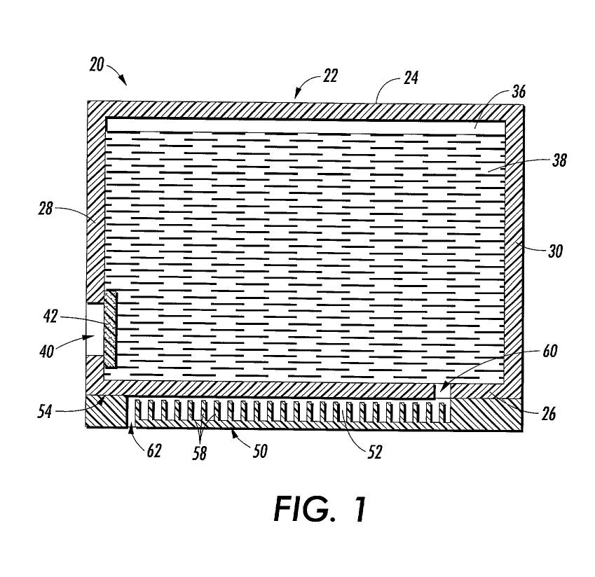

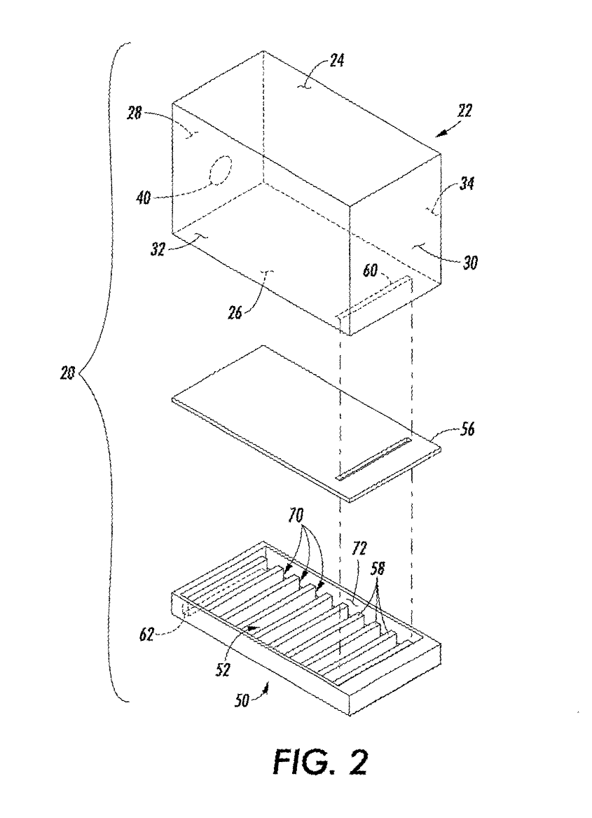

Referring now to FIGS. 1 and 2 (which are illustrative and are not drawn to scale), an ink cartridge 20 according to a first embodiment includes a housing 22 formed of a plurality of walls. In the particular cartridge illustrated, the walls of the housing include a top wall 24, a substantially parallel and opposed bottom wall 26, and four side walls 28, 30, 32, 34 extending between the top and bottom walls enclosing an interior ink chamber 36 for storing ink 38.

An ink outlet opening 40 passes through the sidewall 28 of the housing 22. A porous member 42, formed of felt or other suitable porous material or membrane, is placed over ink outlet opening 40. The outlet opening provides the point at which the cartridge interacts with the ink jet printhead (not shown), and through which ink 38 is supplied from the cartridge to the ink jet printhead. The outlet opening is shown in one of the sidewalls of the housing and is preferably at a location near the bottom of the wick chamber. However, the outlet opening may alternatively be provided through the bottom wall 26 of the housing.

A seal (not shown) preferably covers the outlet opening 40 prior to installation of the cartridge 20 in the printing apparatus (not shown). For example, metallic tape, foil, or other material that the ink cannot penetrate is placed on and sealed to the outer surface of the wall having the outlet opening, in order to seal the outlet opening. The user removes the seal before inserting the cartridge into the printing apparatus. However, in certain configurations, the seal may remain in place, and be punctured or otherwise penetrated by the printhead or other structure (not shown) when the cartridge is installed in the printer.

A capillary plate 50 having a recess 52 molded into an upper surface thereof is sealingly attached to the lower surface 54 of the bottom wall 26 of the housing 22, such that recess 52 defines a chamber. An optional gasket 56 is illustrated in FIG. 2, but not in FIG. 1. A plurality of parallel fins or ribs 58 extend up from a lower inner surface of the recess 52 toward the lower surface 54 of the housing 22. The fins 58 terminate a short distance from the lower surface 54 of the housing 22, thereby forming a series of small gaps between the tops of the fins and the housing.

A fluid passage or through hole 60 passes through the bottom wall 26 of the housing 22. Passage 60 provides fluid communication between the ink chamber 36 and a first end of the capillary chamber 52. A second passage or vent opening 62 passes through the capillary plate 50, fluidly communicating a second end of the capillary chamber with the ambient environment. With this construction, the ink chamber 36 is in fluid communication with the external atmosphere via passage 60, capillary chamber 52, and vent opening 62.

In the illustrated embodiment, the fluid passage 60 and the capillary plate 50, which includes the vent opening 62 and the capillary chamber 52, are located at the bottom of the wick chamber. The fluid passage and vent opening may, however, be alternatively located at one the housing sidewalls or at the top of the wick chamber. Also, the recess 52 and fins 58 may alternatively be molded into any one of the housing outer walls. In which case, the plate 50 would simply be a flat planar plate. The vent opening may be sealed by a removable seal (not shown) that is removed by the operator prior to installation of the cartridge 20 in a printer.

The gaps between the tops of the fins 58 and the lower surface 54 of the housing 22 are sized to form a series of capillary channels or openings between the passage 60 and the vent opening 62. The size and number of capillaries are selected to allow air to enter the cartridge through the vent opening only when the interior pressure has been reduced below the desired negative pressure relative to the external environment.

When ink is drawn from the ink outlet 40 by a printhead, the pressure within the ink chamber 36 is reduced below the desired negative pressure. The reduced pressure within the ink chamber causes air to be drawn into the cartridge through the vent opening 62, the capillary chamber 52, and the passage 60. Once the pressure within the ink chamber has been rebalanced to the desired negative pressure, no more air is drawn in through the capillary chamber. Thus, the capillaries in the capillary chamber serve the same function of maintaining the desired negative pressure, as does the wick in the existing cartridges.

If the vent opening 62 is opened, such as by removing the seal (not shown), when the internal pressure in the ink chamber 36 is higher than the external ambient pressure, then the air inside the ink chamber 36 expands. When the air inside the ink chamber expands, some of the ink 38 in the ink chamber is pushed through the passage 60 and into the capillary chamber 52 and some of the air in the capillary chamber escapes trough the vent opening 62. The excess pressure within the ink chamber is thereby relieved. The ink forced through the passage 60 is trapped in the spaces or grooves between the fins 58 in the capillary chamber 52. The incidence of sudden ejection or squirting of ink from the vent opening when the seal is removed is reduced by inclusion of a substantial volume between the fins in the capillary chamber.

In the particular form of the present invention illustrated in FIG. 2, at least one end 70 of the fins 58 terminate a short distance from the inner surface 72 of the sidewall of the capillary cap 50. A small notch or gap is thus formed in each rib. FIG. 2 illustrates the notches as being aligned along one edge of the capillary chamber. The notches on adjacent ribs may alternate from one edge to the other or be staggered, such that each notch is offset from the notches in each adjacent rib. The stagger may be in a regular pattern, such as a curve or straight diagonally extending line, or a purely random pattern. The notches may also be omitted entirely, such that each fin extends entirely from one sidewall of the capillary chamber to the other.

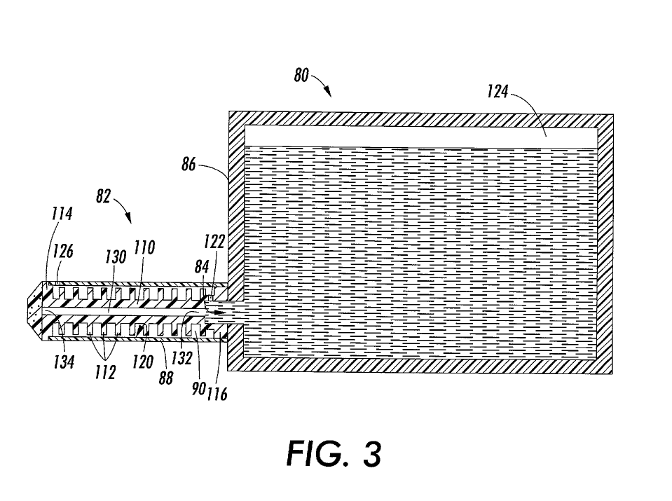

A cartridge 80 according to an alternative form of the present invention is illustrated in cross-section in FIG. 3 (which is illustrative and is not drawn to scale). Alternative cartridge 80 includes a capillary cylinder 82 extending from fluid passage 84 in an outer wall 86 of the cartridge. The capillary cylinder 82 includes a cylindrical outer wall 88 enclosing a capillary chamber 90. A cylindrical core 110 having a plurality of parallel annular fins or ribs 112 radiating therefrom is mounted concentrically within the capillary chamber. The core is concentrically located and secured in place by annular end flanges 114, 116 integrally formed on each end of the core. The flanges are sealingly affixed to the ends of the cylindrical outer wall 88 and thereby seal the capillary chamber 90.

The outer peripheral ends of the annular fins 112 terminate a short distance from an inner surface 120 of the outer wall 88, thereby forming a plurality of annular capillary gaps or passages between the fins and the outer wall. A vent port 122 extending through the core 110 communicates a first end of the capillary chamber 90 with the ink chamber 124. A vent opening 126 in the outer wall 88 communicates a second end of the capillary chamber with the external environment. The ink chamber is thus in fluid communication with the external environment via the vent opening 126, the capillary chamber 90, and the vent port 122. The fins 112 may have notches formed therein in any desired pattern, for example, in a straight line, in a spiral or randomly, as previously described in relation to the ribs on the capillary plate.

An ink outlet passage 130 extends axially through the center of the core 110. The ink outlet passage is open at both ends, thereby forming an ink outlet port 132 in fluid communication with the ink chamber 124 and an ink outlet opening 134 in fluid communication with the external environment. A porous member 136, formed of felt or other suitable porous material or membrane, is placed over the ink outlet opening 134. The outlet opening provides the point at which the cartridge 80 interacts with the printhead (not shown), and through which ink is supplied from the cartridge to the ink jet printhead.

The capillary cylinder 82 is illustrated extending horizontally form a sidewall of the cartridge 80 and is preferably, but not necessarily, located in a lower portion of the cartridge. The capillary cylinder may alternatively be inclined or may extend from the bottom wall of the cartridge. It will be appreciated that the location of the vent opening 126 and the vent port 122 may vary from those illustrated and described herein, provided the two openings are located at opposite ends of the capillary chamber 90. For example, the vent opening 126 and the vent port 122 may alternatively pass through the end flanges 114, 116. In which case, the in outlet opening 84 may be enlarged to communicate with the vent port 122, or a separate bore may be provided through the wall 82 of the housing in alignment with the vent port 122.

The present invention, as described by way of example above, eliminates the need for a wick in a wick chamber or in the ink chamber. Substantially the entire interior volume of a cartridge according to the present invention is therefore available for storing ink, whereas the wick in the prior art cartridges consumes a substantial portion of the available volume inside the cartridge. A cartridge according the present invention is therefore capable of storing a greater quantity of ink than a prior art cartridge of the same size that contains a wick. Furthermore, the wick absorbs and retains a substantial quantity of ink that cannot be removed by the printhead. Ink that is absorbed and retained by the wick is discarded with the spent cartridge. A cartridge according to the present invention does not contain a wick. Substantially all of the ink stored in the ink chamber can be drawn from the cartridge by the printhead. As a result, less ink is discarded with a cartridge according to the present invention, than with a cartridge containing a wick. Another benefit of eliminating the wick is, additives that would be absorbed, filtered by, or detrimentally react with the wick material, may be effectively added to the ink and safely effectively and used in a cartridge according to the present invention.

Exemplary embodiments of the present invention have been described. After reading the description, those skilled in the art will identify various modifications that can be made to the embodiments described above without departing from the invention. For example, other shapes of ink cartridges may incorporate the invention. Also, other shapes may be incorporated into the projections, rib, fins or other structures may be used. For example, the capillary member 82 may have any desired cross-sectional shape, such as square, rectangular, ovular, etc. In addition, the vent opening, the outlet opening, and other elements may be placed in different locations. Therefore, the above description is illustrative, and the scope of the claimed invention is not to be limited to the particular embodiments described above.

What is claimed:

1. An ink cartridge comprising:
a housing defining an ink chamber for storing ink with an ink outlet opening in said housing;
a rigid capillary member fluidly communicating said ink chamber with the external environment for maintaining said ink chamber at a reduced pressure relative to the external environment.

2. A cartridge according to claim 1, wherein said capillary member defines capillary chamber, with a plurality of fins extending from a first inner surface of said capillary chamber toward an opposing second inner surface of said capillary chamber, outer ends of said fins being spaced from said second inner surface, thereby defining a plurality of capillary spaces between said fins and said second inner surface, a fluid passage communicates a first end of said capillary chamber with said ink chamber, and a vent opening in said capillary member fluidly communicates a second opposing end of said capillary chamber with the external environment.

3. A cartridge according to claim 2, wherein one of said first and second inner surfaces of said capillary chamber is formed by an outer wall of said housing.

4. A cartridge according to claim 3, wherein said one of said first and second inner surfaces of said capillary chamber is formed by a bottom wall of said housing.

5. A cartridge according to claim 3, wherein said one of said first and second inner surfaces of said capillary chamber is formed by a sidewall of said housing.

6. A cartridge according to claim 3, wherein said one of said first and second inner surfaces of said capillary chamber is formed by a top wall of said housing.

7. A cartridge according to claim 3, wherein said first inner surface of said capillary chamber is formed by said housing outer wall.

8. A cartridge according to claim 3, wherein said second inner surface of said capillary chamber is formed by said housing outer wall.

9. A cartridge according to claim 2, wherein said first inner surface is formed by a hollow tubular wall and said second inner surface is formed by an axially extending core centrally located within said tubular wall, with an ink outlet passage that extends longitudinally through a center of said core, one end of said outlet passage is in fluid communication with said ink outlet opening and the other end of said fluid passage is open to the external atmosphere.

10. A cartridge according to claim 2, wherein said second inner surface is formed by a hollow tubular wall and said first inner surface is formed by an axially extending core centrally located within said tubular wall, with an ink outlet passage that extends longitudinally through a center of said core, one end of said outlet passage is in fluid communication with said ink outlet opening and the other end of said fluid passage is open to the external atmosphere.

11. A cartridge according to claim 10, wherein said tubular wall is cylindrical.

12. A cartridge according to claim 11, wherein said fins are annular and said gaps are annular.

13. A cartridge according to claim 10, further comprising a notch in each said fin.

14. A cartridge according to claim 13, wherein each said notch is offset from each said notch in adjacent said fins.

15. A cartridge according to claim 2, further comprising a notch in each said fin.

16. A cartridge according to claim 15, wherein each said notch is offset from each said notch in adjacent said fins.

17. An inkjet printer including a cartridge according to claim 2.

18. An inkjet printer having a cartridge according to claim 10.
